(19) United States
(12) Patent Application Publication
(10) Pub. No.: US 2026/0073623 A1
(43) Pub. Date: Mar. 12, 2026

(54) GAUSSIAN SYNTHESIS FOR SPATIAL FRAMES

(71) Applicant: QUALCOMM Incorporated, San Diego, CA (US)

(72) Inventors: Athul GANGADHARAN, Payyannur (IN); Jerin GEO JAMES, Changanacherry (IN); Vinay MELKOTE KRISHNAPRASAD, Bangalore (IN); Sudipto BANERJEE, Kolkata (IN); Harendra Pratap SINGH, Bengaluru (IN); Sourabh PRAJAPATI, Bangalore (IN)

(21) Appl. No.: 18/882,462

(22) Filed: Sep. 11, 2024

(51) Int. Cl. G06T 15/20; G06T 15/50

(52) U.S. Cl. CPC G06T 15/205; G06T 15/503

(57) ABSTRACT

This disclosure provides systems, devices, apparatus, and methods, including computer programs encoded on storage media, for synthesizing spatial videos using Gaussian models. A first graphics processor (e.g., at a server) may obtain a set of frames. The first graphics processor may determine a set of Gaussians based on the set of frames. A second graphics processor (e.g., at a client), may transmit a request for a set of Gaussians. The first graphics processor may receive the request for at least a subset of the set of Gaussians. The first graphics processor may transmit an indication of at least the subset of the set of Gaussians in response to the request. The second graphics processor may receive the set of Gaussians in response to a transmission of the request. The second graphics processor may perform alpha composition based on the received set of Gaussians and a depth-based projection.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, ones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor. Current techniques may not address optimization of Gaussians for synthesizing spatial videos. There is a need for improved Gaussian optimization techniques.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus a memory; and at least one processor coupled to the memory and, based at least in part on information stored in the memory, the at least one processor may be configured to obtain a set of frames. The at least one processor may be configured to determine a set of Gaussians based on the set of frames. The at least one processor may be configured to receive a request for at least a subset of the set of Gaussians. The at least one processor may be configured to transmit an indication of at least the subset of the set of Gaussians in response to the request.

In an aspect of the disclosure, a method, a computer-readable medium, and an apparatus are provided. The apparatus a memory; and at least one processor coupled to the memory and, based at least in part on information stored in the memory, the at least one processor may be configured to transmit a request for a set of Gaussians. The at least one processor may be configured to receive the set of Gaussians in response to a transmission of the request. The at least one processor may be configured to perform depth-based reprojection based on a display pose. The at least one processor may be configured to perform alpha composition based on the received set of Gaussians and a performance of depth-based projection based on the display pose.

In some aspects, the techniques described herein relate to a method of graphics processing, including: obtaining a set of frames; determining a set of Gaussians based on the set of frames; receiving a request for at least a subset of the set of Gaussians; and transmitting an indication of at least the subset of the set of Gaussians in response to the request.

In some aspects, the techniques described herein relate to a method, where obtaining the set of frames includes receiving the set of frames from at least one of a set of cameras or a client entity.

In some aspects, the techniques described herein relate to a method, where the request includes a display pose, further including: selecting the subset of the set of Gaussians based on the display pose.

In some aspects, the techniques described herein relate to a method, where selecting the subset of the set of Gaussians based on the display pose includes: determining an upper trajectory limit and a lower trajectory limit based on the display pose; and selecting the subset of the set of Gaussians based on the determined upper trajectory limit and the determined lower trajectory limit.

In some aspects, the techniques described herein relate to a method, where determining the upper trajectory limit and the lower trajectory limit based on the display pose includes: determining the upper trajectory limit and the lower trajectory limit based on a depth discontinuity threshold from the display pose.

In some aspects, the techniques described herein relate to a method, where selecting the subset of the set of Gaussians based on the display pose includes: determining a region of interest (ROI) based on the display pose; and selecting the subset of the set of Gaussians based on the determined ROI.

In some aspects, the techniques described herein relate to a method, where the request includes a request for the set of Gaussians, further including: selecting the set of Gaussians for the indication based on the request.

In some aspects, the techniques described herein relate to a method of graphics processing, including: transmitting a request for a set of Gaussians; receiving the set of Gaussians in response to a transmission of the request; performing depth-based reprojection based on a display pose; and performing alpha composition based on the received set of Gaussians and a performance of depth-based projection based on the display pose.

In some aspects, the techniques described herein relate to a method, further including: rasterizing the received set of Gaussians before a performance of alpha composition based on the depth-based projection and the received set of Gaussians.

In some aspects, the techniques described herein relate to a method, further including obtaining the display pose before performing the depth-based reprojection.

In some aspects, the techniques described herein relate to a method, where the request includes an indication of the display pose, where the received set of Gaussians is based on the display pose.

In some aspects, the techniques described herein relate to a method, further including: selecting a subset of the set of Gaussians based on the display pose.

In some aspects, the techniques described herein relate to a method, where selecting the subset of the set of Gaussians based on the display pose includes: determining an upper trajectory limit and a lower trajectory limit based on the display pose; and selecting the subset of the set of Gaussians based on the determined upper trajectory limit and the determined lower trajectory limit.

In some aspects, the techniques described herein relate to a method, where determining the upper trajectory limit and the lower trajectory limit based on the display pose includes: determining the upper trajectory limit and the lower trajectory limit based on a depth discontinuity threshold from the display pose.

In some aspects, the techniques described herein relate to a method, where selecting the subset of the set of Gaussians based on the display pose includes: determining a region of interest (ROI) based on the display pose; and selecting the subset of the set of Gaussians based on the determined ROI.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example of a Gaussian splatting technique, in accordance with one or more techniques of this disclosure.

FIG. 4 illustrates an example of synthesizing a set of frames based on relevant Gaussians, in accordance with one or more techniques of this disclosure.

FIG. 5 illustrates an example of a server and a client configured to utilize Gaussians to synthesize a set of frames, in accordance with one or more techniques of this disclosure.

FIG. 6 illustrates an example of a server and a client configured to utilize Gaussians to synthesize a set of frames, in accordance with one or more techniques of this disclosure.

FIG. 7A illustrates an example of regions of interest (ROI) about a capture trajectory, in accordance with one or more techniques of this disclosure.

FIG. 7B illustrates an example of a method of optimizing Gaussians about an ROI, such as the ROI shown in FIG. 7A, in accordance with one or more techniques of this disclosure.

FIG. 8 illustrates an example of a server and a client configured to train Gaussians and use at least some of the Gaussians to render an image, in accordance with one or more techniques of this disclosure.

FIG. 9 illustrates another example of a server and a client configured to train Gaussians and use at least some of the Gaussians to render an image, in accordance with one or more techniques of this disclosure.

FIG. 10 is a call flow diagram illustrating example communications between a server and a client, in accordance with one or more techniques of this disclosure.

FIG. 11 is a flowchart of an example method of graphics processing in accordance with one or more techniques of this disclosure.

FIG. 12 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways.

Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely-rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

Spatial videos may be displayed to a screen of a head-mounted display (HMD) which is world locked. When the user changes a head pose, the HMD may display the screen from the new perspective. In some aspects, a system may train three-dimensional (3D) Gaussian splats (GS), also referred to as 3D Gaussians, based on frames from captured spatial videos to learn the 3D structure and color information in regions having sharp depth discontinuities. A Gaussian may be a function used to represent a probability density function of a normally distributed random variable, for example a symmetric bell curve with a standard deviation about a peak of the bell curve. A Gaussian splat, or 3D Gaussian, may be a technique used to learn a 3D scene based on a set of two-dimensional (2D) images from different viewing directions. Each 3D Gaussian may be trained to determine a set of parameters, such as a position, covariance matrix, a view dependent color, and/or an alpha. Given a camera direction, a system may project a 3D Gaussian to a 2D representation. The system may rasterize the 2D representation to form a 2D image. While training a 3D Gaussian, the system may compare the 2D images with training images, and back propagate loss to optimize the parameters of the 3D Gaussian. The system may infer such optimized 3D Gaussians to synthesize new views of a scene. At the time of video consumption, the frames may be rendered as a function of the head pose of the user using the learnt Gaussians to handle disocclusions. However, learning the entire 3D scene with high quality may use more storage and bandwidth than is available on user devices. In some aspects, an offline device (e.g., a server) may use red green blue depth (RGBD) frames to optimize Gaussians to learn a 3D scene in regions around a depth discontinuity. During consumption, a server may obtain a display pose (e.g., transmitted from a client). The server may then determine the potential regions of disocclusion for the given display pose and send a subset of Gaussians which are located in those regions. The client receives the display pose and may reproject the frame. The reprojected frame may have holes. The client may use the Gaussians provided by the server to fill these holes. In some examples, a graphics processor (or graphics processor system) at a server may obtain a set of frames. The graphics processor may determine a set of Gaussians based on the set of frames. For example, the graphics processor may use frames from captured spatial videos to train Gaussian splats. Such Gaussian splats may be used to determine a 3D structure and color information in regions that have sharp depth discontinuities. At the time of video consumption, a GPU may render frames based on the head pose of a user, and may use the learned Gaussians to handle disocclusions. The graphics processor may receive a request for at least a subset of the set of Gaussians. The graphics processor may transmit an indication of at least the subset of the set of Gaussians in response to the request.

In some examples, a graphics processor (or graphics processor system) at a client may transmit a request for a set of Gaussians. The graphics processor may receive the set of Gaussians in response to a transmission of the request. The graphics processor may perform depth-based reprojection on a frame based on a display pose. The graphics processor may perform alpha composition based on the received set of Gaussians and a performance of depth-based projection based on the display pose. Alpha composition may include, for example, compositing an image obtained by reprojection and the image obtained from splatting a set of Gaussians based on a hole mask. For example, for a pixel of an image, if the hole mask value for the pixel is zero, the graphics processor may select a pixel from a reprojection image, and if the hole mask value for the pixel is one, the graphics processor may select a pixel from the image obtained by Gaussian splatting. In other words, the graphics processor may use the output from Gaussians in the regions of holes left by depth-based reprojection, and use the output from the reprojection image in the non-hole regions. In other aspects, alpha reprojection may include compositing an image buffer for the plurality of Gaussians based on the provided alpha values for each of the plurality of Gaussians. In some aspects, the graphics processor may simply overlay a pixel from a first image (e.g., a foreground image) with a pixel from a second image (e.g., a background image) to perform alpha composition. Alpha composition may combine a plurality of Gaussians to create an appearance of partial or full transparency in a region of a frame. Particular aspects of the subject matter described in this disclosure can be implemented to realize one or more of the following potential advantages. In some examples, by leaning Gaussians in the regions of depth discontinuities instead of an entire scene, the described techniques can be used to save memory and compute.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

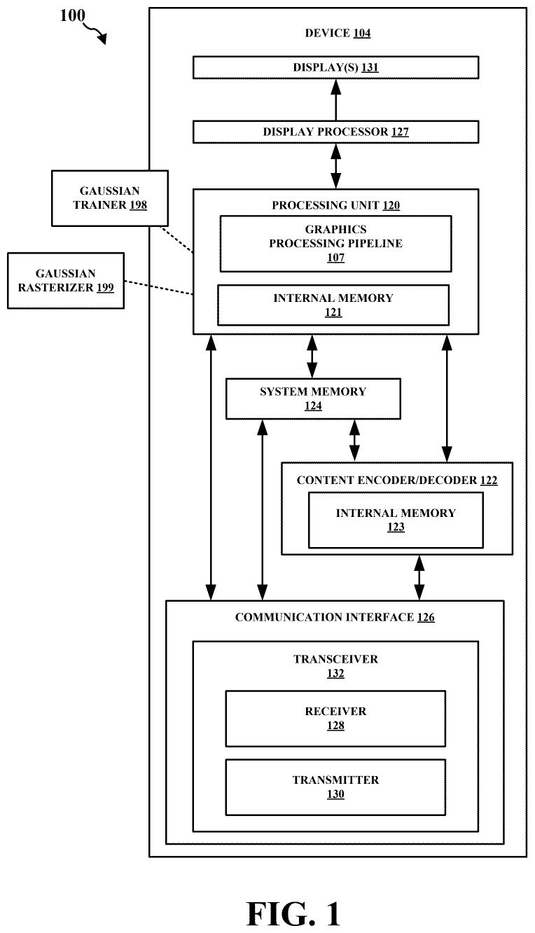

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content. The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a Gaussian trainer 198 configured to obtain a set of frames. The Gaussian trainer 198 may be configured to determine a set of Gaussians based on the set of frames. The Gaussian trainer 198 may be configured to receive a request for at least a subset of the set of Gaussians. The Gaussian trainer 198 may be configured to transmit an indication of at least the subset of the set of Gaussians in response to the request. Although the following description may be focused on graphics processing, the concepts described herein may be applicable to other similar processing techniques. Referring again to FIG. 1, in certain aspects, the processing unit 120 may include a Gaussian rasterizer 199 configured to transmit a request for a set of Gaussians. The Gaussian rasterizer 199 may be configured to receive the set of Gaussians in response to a transmission of the request. The Gaussian rasterizer 199 may be configured to perform depth-based reprojection on a frame based on a display pose. The Gaussian rasterizer 199 may be configured to perform alpha composition based on the received set of Gaussians and a performance of depth-based projection based on the display pose. Although the following description may be focused on graphics processing, the concepts described herein may be applicable to other similar processing techniques. A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

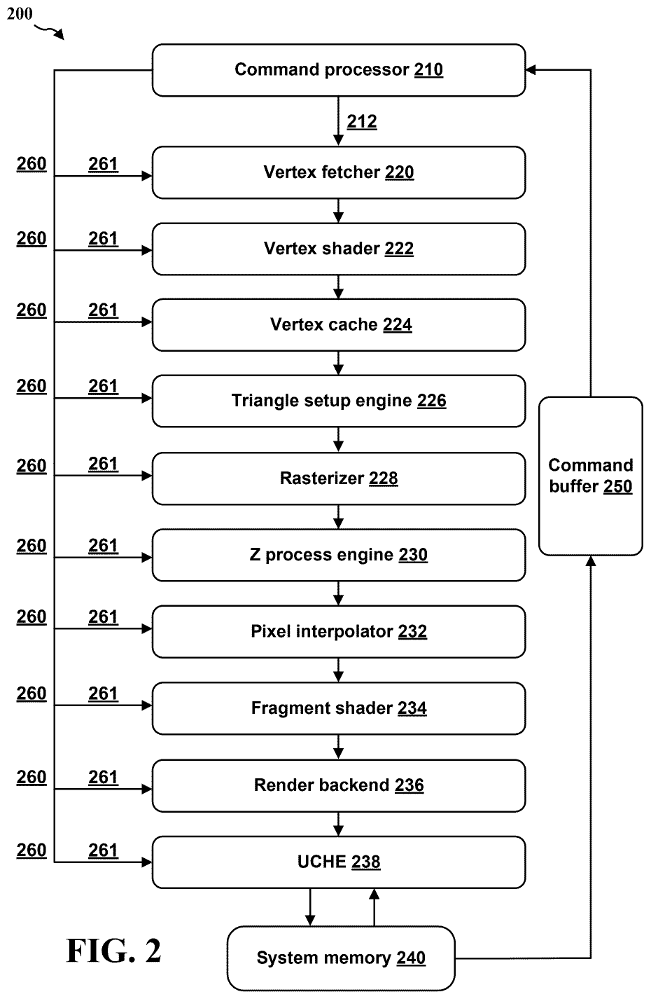

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

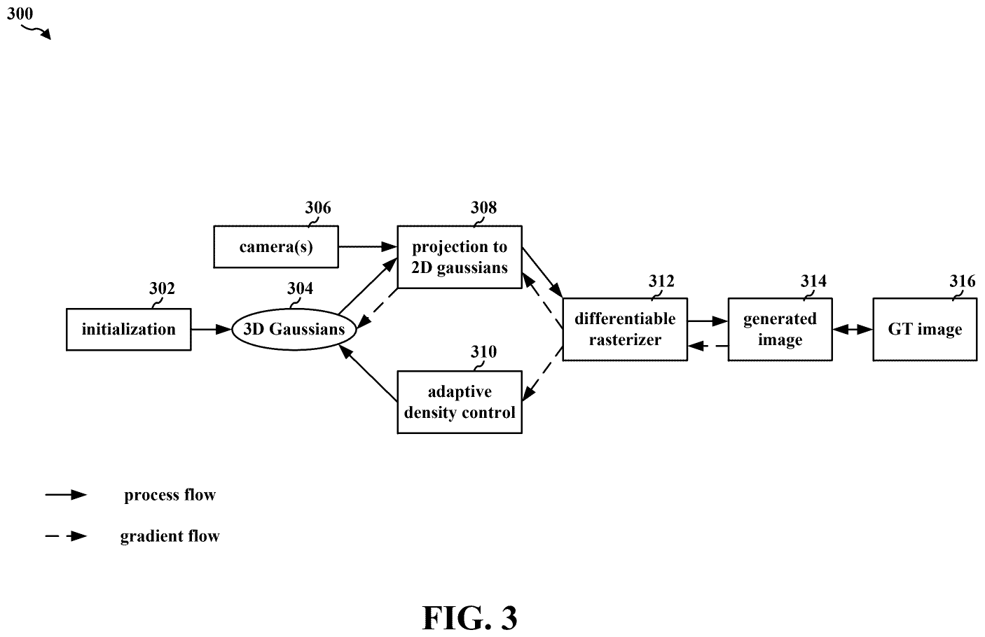

FIG. 3 is a diagram 300 of a Gaussian splatting technique. At 302, the system may initialize a Gaussian splatting technique for rendering and training Gaussians. At 304, the system generate a set of 3D Gaussians based on a set of 2D images, for example images captured by the set of cameras 306 or another set of cameras, which may be used to obtain a set of 2D images of a 3D scene from different viewing directions. The set of 2D images may be a sparse set of images, which may not cover all angles of an object in the 3D scene. Each of the 3D Gaussians may have a position, covariance matrix, a view dependent color, and/or an alpha.

The Gaussian trainer may obtain a display pose of a user. For example, the set of cameras 306 may indicate a head pose and/or an eye pose of a user to the system. At 308, the system may obtain the camera direction from the set of cameras 306, and project the 3D Gaussians generated at 304 to a set of 2D Gaussians for each display of an HMU. At 312, a differentiable rasterizer may rasterize the 2D Gaussians to generate an image at 314. At 316, the system may obtain a ground truth (GT) image, for example from a set of cameras or a storage device that holds a set of training images. The system may back-propagate the loss (difference between the GT image at 316 and the generated image at 314) through the differentiable rasterizer at 312 and an adaptive density control 310 to optimize parameters of each of the 3D Gaussians generated at 304. The parameters may include, for example, a position, covariance matrix, a view dependent color, and/or an alpha. A Gaussian rasterizer may use the optimized 3D Gaussians at 304 to synthesize new views of the generated image at 314, which may, again, be compared against a GT image at 316.

In some aspects, the system may optimize Gaussians for the entire scene and use the Gaussians to render the scene from the head pose obtained from the set of cameras 306. However, using a Gaussian trainer to learn an entire 3D scene with high quality may use millions of Gaussians and gigabytes of memory to render an entire scene. Such a technique may use a great deal of resources, such as storage resources, bandwidth/transmission resources, time resources, and computation resources. In other aspects, the system may use Gaussians in specified regions of interest (ROI), for example where a discontinuity of the area is above a threshold amount. In other words, the system may use a traditional reprojection method whenever a good outcome is realized (e.g., when a discontinuity is less than or equal to a discontinuity threshold value), and use Gaussians where the traditional reprojection method fails (e.g., the discontinuity is greater than the discontinuity threshold value). Areas where a discontinuity is less than or equal to a discontinuity threshold value may be referred to as areas with holes or stretching. By training/learning Gaussians in regions of depth discontinuities, or selecting Gaussians in regions of depth discontinuities, resource use may be minimized.

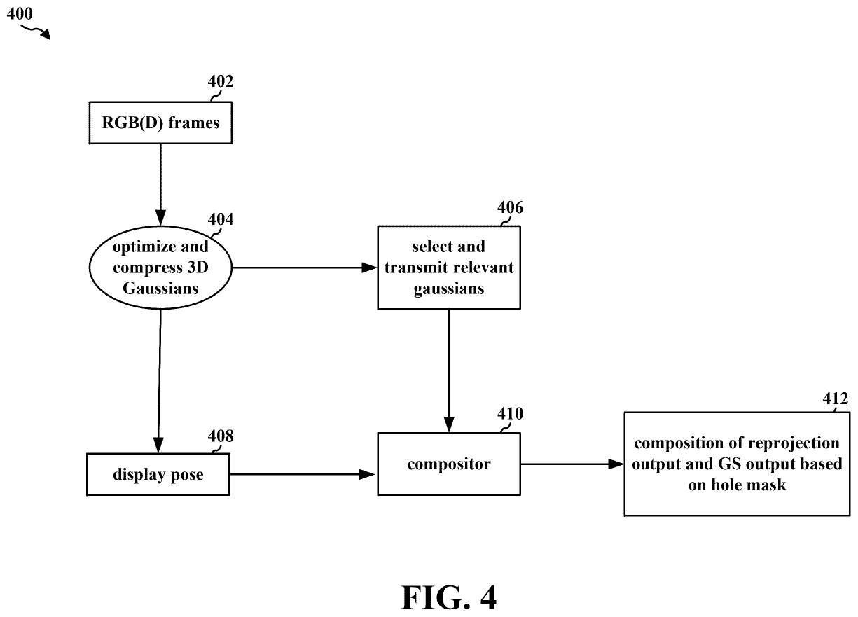

FIG. 4 is a diagram 400 of a technique for synthesizing a set of frames based on relevant Gaussians. In some aspects, a Gaussian trainer may be configured to utilize such a technique. At 402, the Gaussian trainer may obtain a set of RGBD frames, for example as captured by a set of stereo cameras. In some aspects, a user may record a scene using stereo cameras and view the scene in 4D in virtual reality (VR) headsets, for example a head-mounted unit (HMU) or a head-mounted display (HMD). In some aspects, a user may record several scenes of the same area in a world-locked scenario. Such a scene may be referred to as a spatial video. A headset may be configured to display a spatial video, or a 4D video, in a set of screens that are world-locked. The headset may be configured to adjust the view of the set of screens to a new perspective in response to a change in the wearer's head pose. In other words, in response to a change in a user's head pose, a set of screens will display a 4D scene from a new viewing direction. In some aspects, when the user changes a head pose, there may be relative movements in the objects in the scene, from the user's perspective, according to the depth of each object in the scene. There may be disocclusions near depth discontinuities. In some aspects, a Gaussian trainer may use frames from captured spatial videos to train Gaussian splats. Such Gaussian splats may include information on the 4D structure and/or color information in regions that have sharp depth discontinuities. At 404, a Gaussian trainer may optimize Gaussians based on the set of RGBD frames obtained at 402 to learn the 4D scene in the regions around depth discontinuity. In some aspects, a user, for example an admin user, may statically define the depth discontinuity threshold, which may be used to determine which areas have depth discontinuity and which areas do not have depth discontinuity. For example, a Gaussian trainer may determine areas whose depth discontinuity is greater or equal than the threshold to have depth discontinuity, and areas whose depth discontinuity is less than the threshold to not have depth discontinuity. In other words, the Gaussian trainer may use the RGBD frames obtained at 402 to optimize the Gaussians and learn the 4D scene in regions around a depth discontinuity. The Gaussian trainer may optimize the Gaussians offline.

At 408, a display pose of the user may be used to contextualize the set of RGBD frames. During consumption, an HMU may transmit the display pose to a server (e.g., a Gaussian trainer), which may determine the potential regions of disocclusions for the received display pose. At 406, the server may select and transmit relevant Gaussians to a Gaussian rasterizer. The server may select a subset of the Gaussians which are located in those regions associated with the display pose (e.g., regions of disocclusions determined based on the display pose). At 410, a client (e.g., a Gaussian rasterizer) that receives the subset of Gaussians may reproject a frame based on the display pose obtained at 408. The reprojected frame may have holes, or regions of severe disocclusions, which may be determined based on a disocclusion threshold. At 412, the Gaussian rasterizer may use the received Gaussians to fill these holes. At the time of video consumption, a Gaussian rasterizer may render the frames as a function of the head poser of the user, and may use the trained/learnt Gaussians to handle the disocclusions. In other words, the client may use the Gaussians provided by the server to fill the holes, or regions of severe disocclusions. The client may output the resulting frames to a storage device, or to a display.

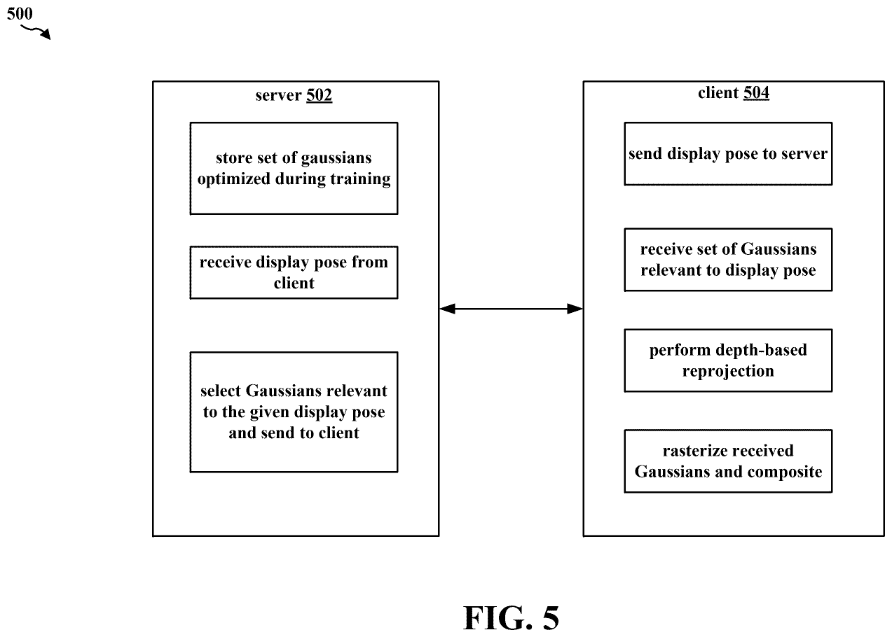

FIG. 5 is a diagram 500 of server 502 and a client 504 optimized to utilize Gaussians to synthesize a set of frames. The server 502 may be configured to train Gaussians based on a set of obtained frames of a video. In some aspects, the set of frames may be obtained from the client 504. For example, the client 504 may transmit an indication of at least some of the set of frames to the server 502, which the server 502 may then use to train a set of Gaussian splats. The server 502 may train the Gaussians offline, in other words not while the client is connected to and actively communicating with the server (e.g., by transmitting display poses to the server 502 or requesting Gaussians from the server 502). The server 502 may store the set of Gaussians optimized during training on a memory, which may then be transmitted to devices that request at least some of the trained set of Gaussians. In some aspects, the server 502 may be configured to train a set of Gaussians based on an entire scene of a spatial video. For example, the server 502 may be functionally coupled to a headset for personal computer virtual reality (PCVR). In other aspects, the server 502 may be configured to train a set of Gaussians based on a region of interest (ROI) in a scene of a spatial video, for example about an object in the spatial video (e.g., a surface of a table that may be configured to virtually support a virtual object).

The client 504 may be configured to perform depth-based reprojection based on the display pose (e.g., the head pose and/or eye pose of a user wearing a HMU at the client). The results of the depth-based reprojection may have holes due to depth discontinuities. In other words, any portion or area of a frame having a depth discontinuity that is greater than or equal to a depth discontinuity threshold may be determined to have a hole. The client 504 may transmit an indication of the display pose to the server 502. The transmitted indication may be of the display pose used by the client 504 to perform the depth-based reprojection. In response to receiving the indication of the display pose, the server 502 may select a subset of the Gaussians trained by the server 502. The subset of the Gaussians may be relevant to the display pose indicated by the client 504. For example, the subset of the Gaussians may be Gaussians that are viewable from the point of view of the display pose. The server 502 may transmit an indication of the selected Gaussians to the client 504. The client 504 may receive the transmitted indication of the selected Gaussians and perform depth-based reprojection based on the selected Gaussians. The client 504 may rasterize the received Gaussians and perform composition to fill holes in the reprojected frame.

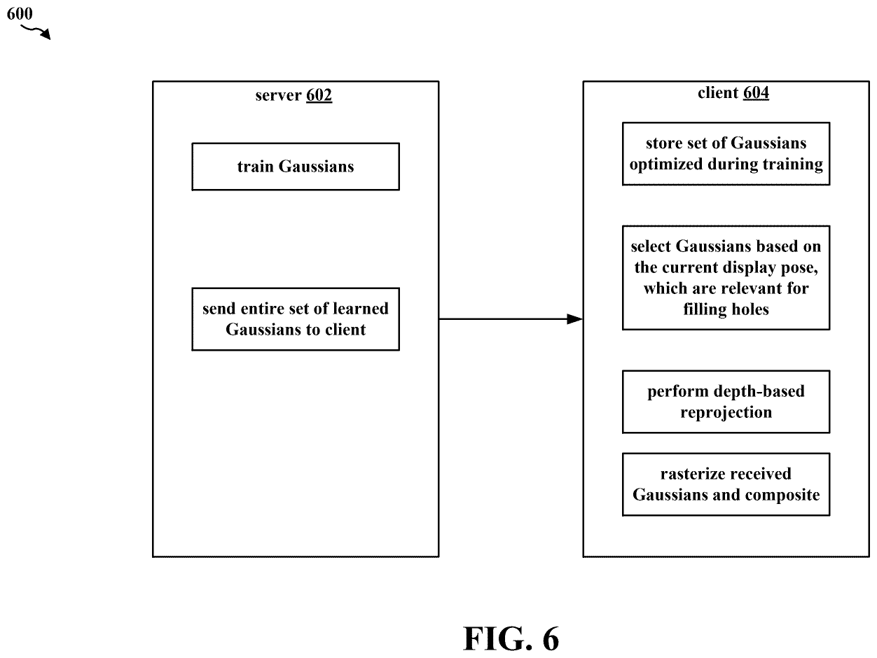

FIG. 6 is a diagram 600 of an example of a server and a client optimized to utilize Gaussians to synthesize a set of frames. The server 602 may train Gaussians offline based on a set of obtained frames of a video. The server 602 may store the set of Gaussians optimized during training on a memory, which may then be transmitted to devices that request at least some of the trained set of Gaussians. The server 602 may be configured to periodically transmit the optimized Gaussians to the client 604, which may store the set of Gaussians. In some aspects, the client 604 may be configured to transmit a request for the set of Gaussians from the server 602. The request may include an indication of an area, for example a room, an object, or an ROI, which is associated with the trained set of Gaussians. In response to receiving the request, the server 602 may transmit the entire set of learned Gaussians to the client 604.

The client 604 may be configured to perform depth-based reprojection based on a display pose (e.g., the head pose and/or eye pose of a user wearing a HMU at the client). The results of the depth-based reprojection may have holes due to depth discontinuities. In other words, any portion or area of a frame having a depth discontinuity that is greater than or equal to a depth discontinuity threshold may be determined to have a hole. The client 604 may select Gaussians relevant to the display pose from the received entire set of Gaussians received from the server 602. In other words, the client may select the Gaussians relevant to the display pose obtained by the client 604. The client 604 may perform depth-based reprojection based on the Gaussians selected at the client. The client 604 may rasterize the received Gaussians and perform composition to fill holes in the reprojected frame.

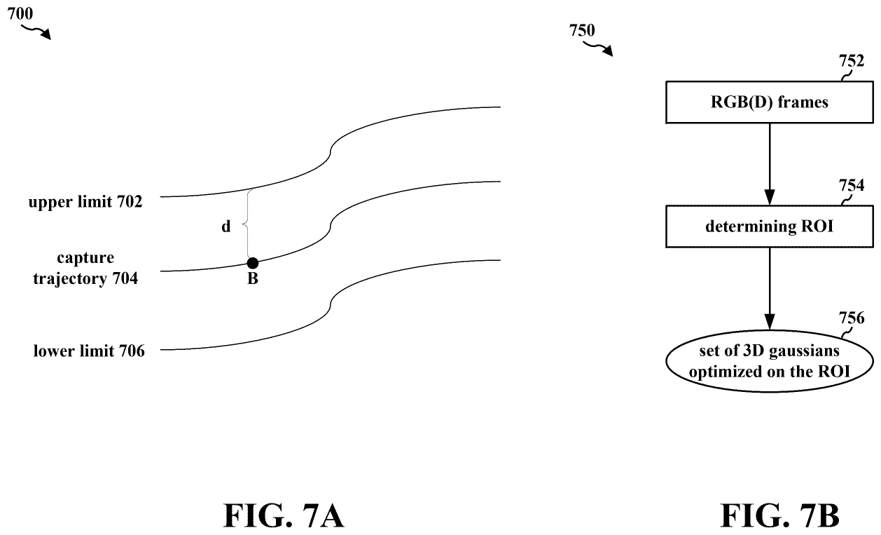

FIG. 7A is a diagram 700 an example of a region of interest (ROI) bounded by an upper limit 702 and a lower limit 706. The capture trajectory 704 may be the captured display pose of a headset, such as an HMU, as the headset moves about an area. This movement may refer to the display pose of an HMU that is captured as the HMU records frames that are used to train a Gaussian trainer. The spot B may represent the captured display pose of the headset at a specific moment of time. The offset d may represent an offset from a captured data trajectory. About each spot B along a capture trajectory 704, the system may define an ROI having an upper limit 702 and a lower limit 706 which bounds the area about which the system generates Gaussians. In other words, a Gaussian trainer may not train Gaussians for an entire 3D scene, but may train Gaussians within the ROI defined by a captured display pose B and an offset d. The system may have a clipping function that clips the ROI by the offset d.

FIG. 7B is a diagram 750 of an example method of optimizing Gaussians about an ROI, such as the ROI defined by the upper limit 702 and the lower limit 706. At 752, a headset may capture a set of RGB(D) frames of a 3D scene. The captured set of RGB(D) frames may have a capture trajectory B. At 754, the system may determine an ROI about each display pose for each frame to optimize the number of trained Gaussians to be restricted around the capture trajectory. In other words, the system may restrict the display pose to be inside an upper limit (e.g., the upper limit 702) and a lower limit (e.g., the lower limit 706) around the capture pose. The system can determine the ROI based on depth discontinuities and the limits of the allowed display pose. At 756, the system may generate a set of 3D Gaussians about the ROI determined at 754. In other words, the set of Gaussians generated may be optimized for pixels within a defined ROI which is bounded by a capture trajectory and an offset.

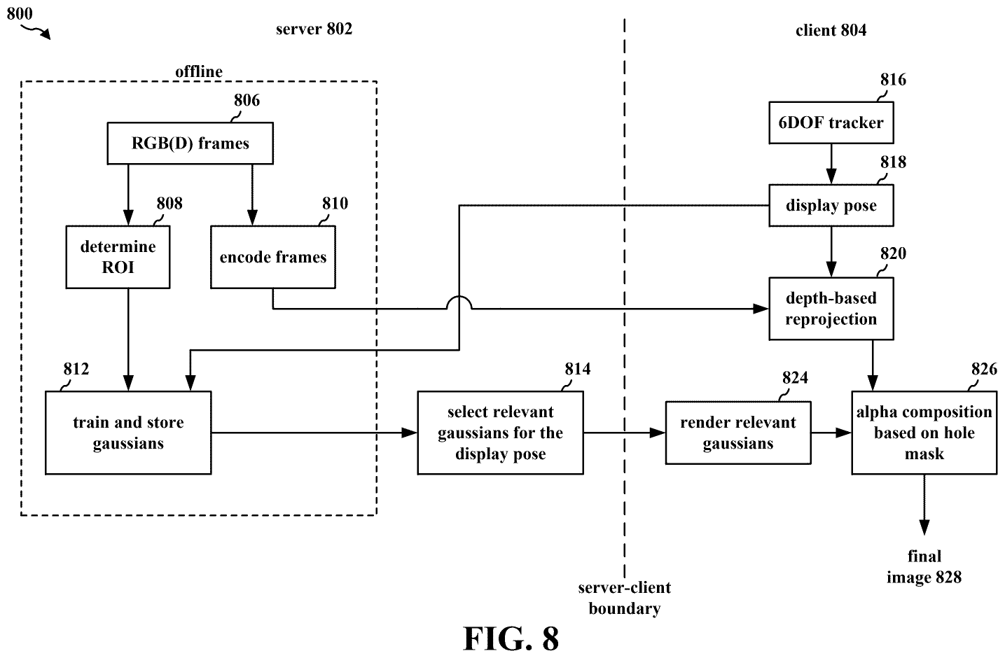

FIG. 8 is a diagram 800 of a server 802 and a client 804 that may be configured to train Gaussians and use at least some of the Gaussians to render a final image 828. At 806, the server 802 may obtain a set of frames of a 3D scene, for example RGB(D) frames captured by a camera moving around an area. Each of the set of frames may be associated with a display pose. At 810, the server 802 may encode a set of frames based on the captured RGB(D) frames. The server 802 may transmit at least some of the encoded frames to the client 804 for performing depth-based reprojection of the 3D scene. At 808, the server 802 may determine an ROI about each display pose associated with each frame obtained at 806, for example by using an upper limit and a lower limit defined by an offset d. At 812, the server 802 may train a set of Gaussians based on the ROI determined at 808. The server 802 may store the set of generated Gaussians on a storage device, for example a non-transient memory accessible by the server 802. The server 802 may perform the tasks of training and storing the Gaussians at 812 offline, and may not be connected to and communicating with the client 804 while training and storing the Gaussians at 812.

At 816, the client 804 may track a movement of a headset. The headset may have a tracker that tracks a display pose of the headset in six degrees of freedom (6DOF). At 818, the client 804 may capture a display pose of the headset. At 820, the client 804 may perform depth-based reprojection based on the encoded frames generated by the server at 810. In some aspects, the client 804 may request the encoded frames based on the display pose obtained at 818. In other aspects, the server 802 may be configured to periodically output encoded frames to the client 804 for use in depth-based reprojection. The reprojection image generated at 820 may have a set of holes, which represent areas having a discontinuity that is greater or equal to a discontinuity threshold. The client 804 may generate a hole mask about the reprojection image that preserves the areas of the frame having a low discontinuity, and allows an alpha composition component to fix the areas of the reprojection image that have discontinuity holes.

In some aspects, the client 804 may transmit an indication of the display pose obtained at 818 to the server 802. At 814, the server 802 may select relevant Gaussians from the Gaussians stored at 812 for the display pose. The server 802 may then transmit the relevant Gaussians to the client 804 in response to receiving the indication of the display pose. At 824, the client 804 may render the relevant Gaussians received from the server 802. At 826, the client 804 may perform alpha composition based on a hole mask. The client 804 may composite the image obtained by reprojection at 820 and the image obtained from splatting a set of Gaussians at 824 based on a hole mask. For example, for a pixel of an image, if the hole mask value for the pixel is zero, the client 804 may select a pixel from a reprojection image, and if the hole mask value for the pixel is one, the client 804 may select a pixel from the image obtained by Gaussian splatting. In other words, the client 804 may use the output from Gaussians in the regions of holes left by depth-based reprojection, and use the output from the reprojection image in the non-hole regions to composite the final image 828.

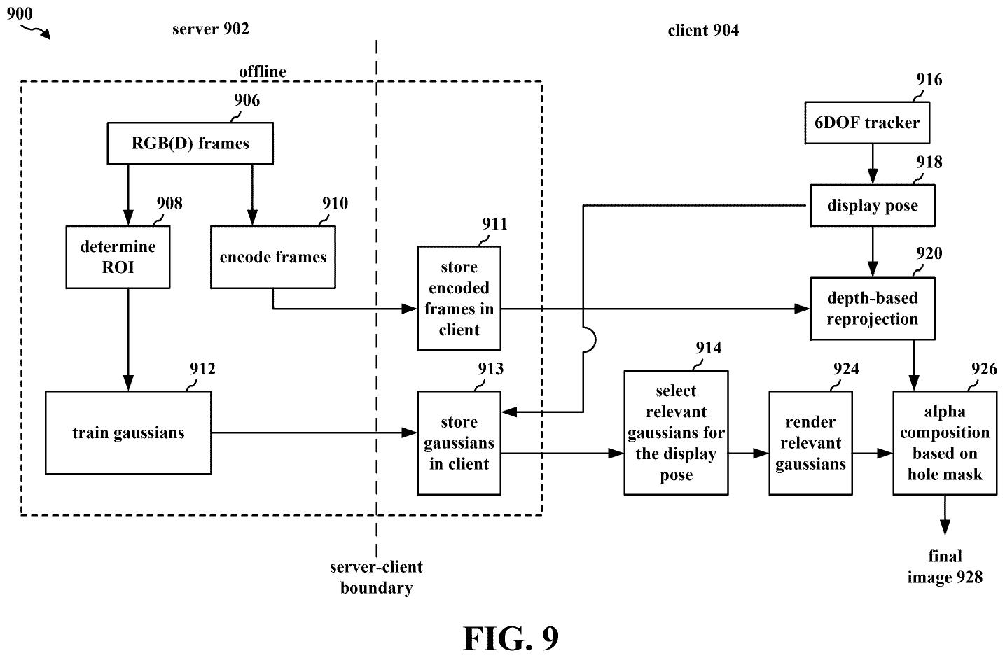

FIG. 9 is a diagram 900 of a server 902 and a client 904 that may be configured to train Gaussians and use at least some of the Gaussians to render a final image 928. At 906, the server 902 may obtain a set of frames of a 3D scene, for example RGB(D) frames captured by a camera moving around an area. Each of the set of frames may be associated with a display pose. At 910, the server 902 may encode a set of frames based on the captured RGB(D) frames. The server 902 may transmit at least some of the encoded frames to the client 904 for performing depth-based reprojection of the 3D scene. At 911, the client 904 may store the encoded frames received from the server 902. At 908, the server 902 may determine an ROI about each display pose associated with each frame obtained at 906, for example by using an upper limit and a lower limit defined by an offset d. At 912, the server 902 may train a set of Gaussians based on the ROI determined at 908. The server 902 may transmit the trained Gaussians to the client 904. The server 902 may transmit all of the trained Gaussians to the client 904. While the server 902 may store the Gaussians on a storage device, for example a non-transient memory accessible by the server 902, at 913, the client 904 can store the Gaussians received from the server 902 on a storage device, for example a non-transient memory accessible by the client 904.

At 916, the client 904 may track a movement of a headset. The headset may have a tracker that tracks a display pose of the headset in six degrees of freedom (6DOF). At 918, the client 904 may capture a display pose of the headset. At 920, the client 904 may perform depth-based reprojection based on the encoded frames saved by the client 904 at 911. The reprojection image generated at 920 may have a set of holes, which represent areas having a discontinuity that is greater or equal to a discontinuity threshold. The client 904 may generate a hole mask about the reprojection image that preserves the areas of the frame having a low discontinuity, and allows an alpha composition component to fix the areas of the reprojection image that have discontinuity holes.

At 914, the client 904 may select relevant Gaussians from the Gaussians stored at 913 for the display pose captured at 918. At 924, the client 904 may render the relevant Gaussians selected at 914. At 926, the client 904 may perform alpha composition based on a hole mask. The client 904 may composite the image obtained by reprojection at 920 and the image obtained from splatting a set of Gaussians at 924 based on a hole mask. For example, for a pixel of an image, if the hole mask value for the pixel is zero, the client 904 may select a pixel from a reprojection image, and if the hole mask value for the pixel is one, the client 904 may select a pixel from the image obtained by Gaussian splatting. In other words, the client 904 may use the output from Gaussians in the regions of holes left by depth-based reprojection, and use the output from the reprojection image in the non-hole regions.

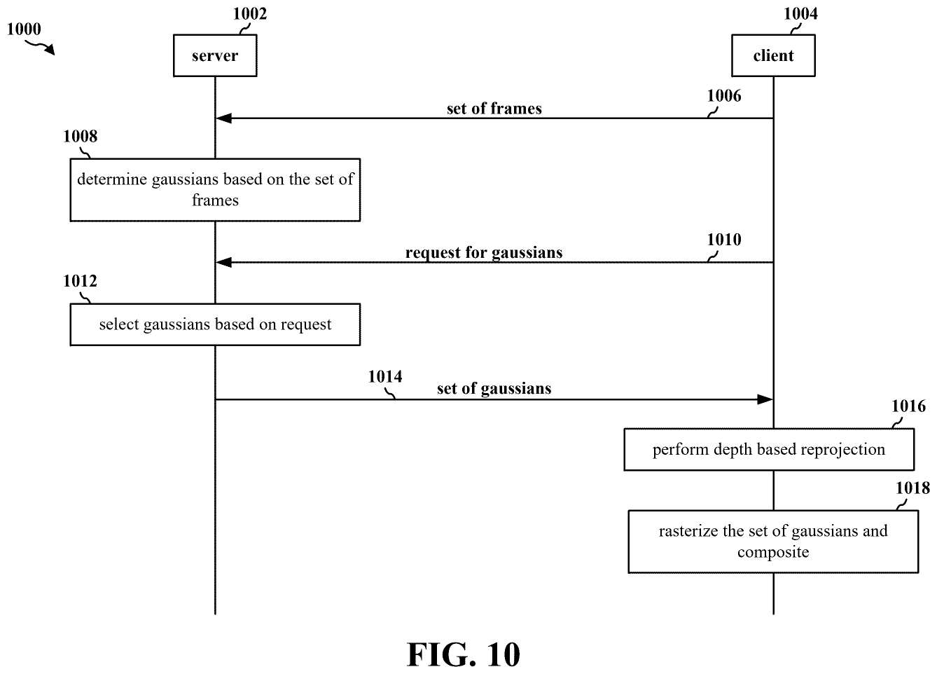

FIG. 10 is a call flow diagram 1000 illustrating example communications between a server 1002 and a client 1004, in accordance with one or more techniques of this disclosure. The client 1004 may transmit an indication of a set of frames 1006 to the server 1002. The server 1002 may receive the set of frames 1006. At 1008, the server 1002 may determine a set of Gaussians based on the set of frames. For example, the server 1002 may determine an ROI about the capture trajectory of the set of frames 1006. The server 1002 may restrict the display pose to be inside an upper limit and lower limit of the capture pose, and may generate 3D Gaussians within the upper limit and lower limits. The client 1004 may transmit an indication of a request 1010 for Gaussians to the server 1002. The server 1002 may receive the indication of the request 1010 from the client 1004. The request may include an indication of a display pose. The request may include an indication of a request for all of the Gaussians rendered by the server 1002.

At 1012, the server 1002 may select Gaussians based on request. The server 1002 may transmit an indication of the set of selected Gaussians 1014 to the client 1004. For example, the server 1002 may select a subset of the Gaussians based on a display pose indicated by the client 1004. In another example, the server 1002 may transmit all of the generated Gaussians to the client 1004, for the client to select at render time. At 1016, the client 1004 may perform depth based reprojection. At 1018, the client 1004 may rasterize the set of Gaussians, which may have been selected at the server 1002, or selected at the client 1004, and may composite an image based on the image generated at 1016 via depth based reprojection and based on the rasterized set of Gaussians at 1018.

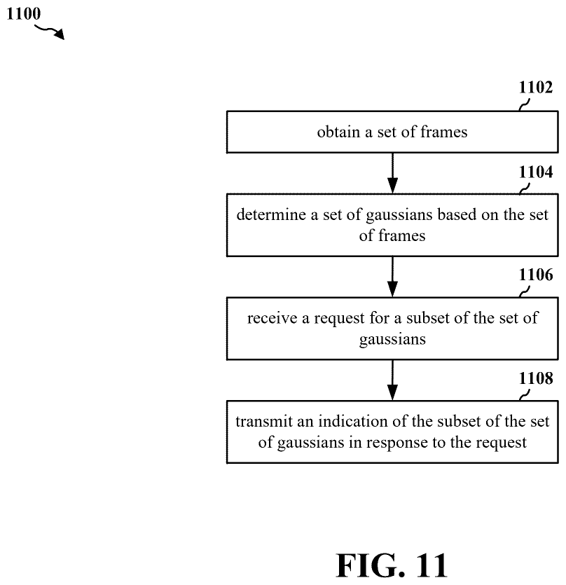

FIG. 11 is a flowchart 1100 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-10.

At 1102, the apparatus may obtain a set of frames. For example, referring to FIG. 11, the server 1002 may obtain a set of frames 1006 from the client 1004. Moreover, 1102 may be performed by the Gaussian trainer 198 in FIG. 1.

At 1104, the apparatus may determine a set of Gaussians based on the set of frames. For example, referring to FIG. 11, at 1008, the server 1002 may determine a set of Gaussians based on the set of frames 1006 received from the client 1004. Moreover, 1104 may be performed by the Gaussian trainer 198 in FIG. 1.

At 1106, the apparatus may receive a request for at least a subset of the set of Gaussians. For example, referring to FIG. 11, the server 1002 may receive a request 1010 for at least a subset of the set of Gaussians determined at 1008. Moreover, 1106 may be performed by the Gaussian trainer 198 in FIG. 1.

At 1108, the apparatus may transmit an indication of at least the subset of the set of Gaussians in response to the request. For example, referring to FIG. 11, the server 1002 may transmit an indication of at least the subset of the set of the Gaussians determined at 1008 to the client 1004, or all of the set of Gaussians determined at 1008 to the client 1004, in response to receiving the request 1010. Moreover, 1108 may be performed by the Gaussian trainer 198 in FIG. 1.

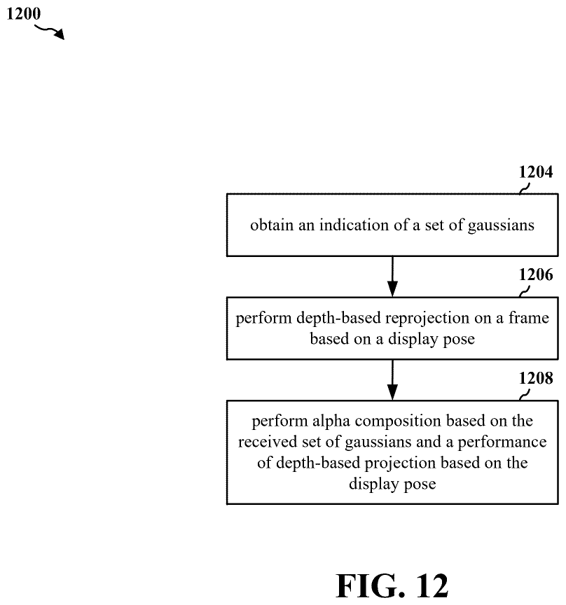

FIG. 12 is a flowchart 1200 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-10.

At 1204, the apparatus may obtain the set of Gaussians. For example, referring to FIG. 10, the client 1004 may obtain the set of Gaussians. In some aspects, the client may transmit a request for a set of Gaussians before obtaining the set of Gaussians. The client may receive the indication of the set of Gaussians after transmitting the request for the set of Gaussians. Moreover, 1202 may be performed by the Gaussian rasterizer 199 in FIG. 1. Moreover, 1204 may be performed by the Gaussian rasterizer 199 in FIG. 1.

At 1206, the apparatus may perform depth-based reprojection on a frame based on a display pose. For example, referring to FIG. 10, the client 1004 may, at 1016, perform depth-based reprojection on a frame based on a display pose. Moreover, 1206 may be performed by the Gaussian rasterizer 199 in FIG. 1.

At 1208, the apparatus may perform alpha composition based on the received set of Gaussians and a performance of depth-based projection based on the display pose. For example, referring to FIG. 10, the client 1004 may, at 1018, perform alpha composition based on the received set of Gaussians and a performance of depth-based projection based on the display pose. In some aspects, the client 1004 may perform alpha composition using an image obtained from a rasterization of a subset of Gaussians and a reprojected image obtained from depth-map based reprojection. The alpha composition may occur based on a hole mask obtained as a result of reprojection. Moreover, 1208 may be performed by the Gaussian rasterizer 199 in FIG. 1.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining a set of frames. The apparatus may further include means for calculating a set of Gaussians based on the set of frames. The apparatus may further include means for receiving a request for at least a subset of the set of Gaussians. The apparatus may further include means for transmitting an indication of at least the subset of the set of Gaussians in response to the request.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for transmitting a request for a set of Gaussians. The apparatus may further include means for receiving the set of Gaussians in response to a transmission of the request. The apparatus may further include means for performing depth-based reprojection based on a display pose. The apparatus may further include means for performing alpha composition based on the received set of Gaussians and a performance of depth-based projection based on the display pose. The apparatus may further include means for obtaining a set of frames. The apparatus may further include means for determining a set of Gaussians based on the set of frames; receiving a request for at least a subset of the set of Gaussians. The apparatus may further include means for transmitting an indication of at least the subset of the set of Gaussians in response to the request. The apparatus may further include means for obtaining the set of frames by receiving the set of frames from at least one of a set of cameras or a client entity. The request may include a display pose. The apparatus may further include means for selecting the subset of the set of Gaussians based on the display pose. The apparatus may further include means for selecting the subset of the set of Gaussians based on the display pose by (a) determining an upper trajectory limit and a lower trajectory limit based on the display pose, and (b) selecting the subset of the set of Gaussians based on the determined upper trajectory limit and the determined lower trajectory limit. The apparatus may further include means for determining the upper trajectory limit and the lower trajectory limit based on the display pose by determining the upper trajectory limit and the lower trajectory limit based on a depth discontinuity threshold from the display pose. The apparatus may further include means for selecting the subset of the set of Gaussians based on the display pose by (a) determining an ROI based on the display pose, and (b) selecting the subset of the set of Gaussians based on the determined ROI. The request may include a request for the set of Gaussians. The apparatus may further include means for selecting the set of Gaussians for the indication based on the request. The means may include the Gaussian trainer 198 of FIG. 1.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for transmitting a request for a set of Gaussians. The apparatus may further include means for receiving the set of Gaussians in response to a transmission of the request. The apparatus may further include means for performing depth-based reprojection based on a display pose. The apparatus may further include means for performing alpha composition based on the received set of Gaussians and a performance of depth-based projection based on the display pose. The apparatus may further include means for rasterizing the received set of Gaussians before a performance of alpha composition based on the depth-based projection and the received set of Gaussians. The apparatus may further include means for obtaining the display pose before performing the depth-based reprojection. The request may include an indication of the display pose. The received set of Gaussians may be based on the display pose indicated by the request. The apparatus may further include means for selecting a subset of the set of Gaussians based on the display pose. The apparatus may further include means for selecting the subset of the set of Gaussians based on the display pose by (a) determining an upper trajectory limit and a lower trajectory limit based on the display pose and (b) selecting the subset of the set of Gaussians based on the determined upper trajectory limit and the determined lower trajectory limit. The apparatus may further include means for determining the upper trajectory limit and the lower trajectory limit based on the display pose by determining the upper trajectory limit and the lower trajectory limit based on a depth discontinuity threshold from the display pose. The apparatus may further include means for selecting the subset of the set of Gaussians based on the display pose by (a) determining an ROI based on the display pose and (b) selecting the subset of the set of Gaussians based on the determined ROI. The apparatus may include means for obtaining an indication of a set of Gaussians. The apparatus may further include means for performing depth-based reprojection based on a display pose. The apparatus may further include means for performing alpha composition based on the received set of Gaussians and a performance of depth-based projection based on the display pose. The apparatus may further include means for rasterizing the received set of Gaussians before a performance of alpha composition based on the depth-based projection and the received set of Gaussians. The apparatus may further include means for obtaining the display pose before performing the depth-based reprojection. The request may include an indication of the display pose. The received set of Gaussians may be based on the display pose. The apparatus may further include means for selecting a subset of the set of Gaussians based on the display pose. The apparatus may further include means for selecting the subset of the set of Gaussians based on the display pose by (a) determining an upper trajectory limit and a lower trajectory limit based on the display pose, and (b) selecting the subset of the set of Gaussians based on the determined upper trajectory limit and the determined lower trajectory limit. The apparatus may further include means for determining the upper trajectory limit and the lower trajectory limit based on the display pose by determining the upper trajectory limit and the lower trajectory limit based on a depth discontinuity threshold from the display pose. The apparatus may further include means for selecting the subset of the set of Gaussians based on the display pose by (a) determining an ROI based on the display pose, and (b) selecting the subset of the set of Gaussians based on the determined ROI The apparatus may further include means for transmitting a request for a set of Gaussians before obtaining the set of Gaussians. The means may include the Gaussian rasterizer 199 of FIG. 1.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is a method of graphics processing, comprising: obtaining a set of frames; determining a set of Gaussians based on the set of frames; receiving a request for at least a subset of the set of Gaussians; and transmitting an indication of at least the subset of the set of Gaussians in response to the request.
Aspect 2 is the method of aspect 1, wherein obtaining the set of frames comprises receiving the set of frames from at least one of a set of cameras or a client entity.
Aspect 3 is the method of aspect 1, wherein the request comprises a display pose, further comprising: selecting the subset of the set of Gaussians based on the display pose.
Aspect 4 is the method of aspect 3, wherein selecting the subset of the set of Gaussians based on the display pose comprises: determining an upper trajectory limit and a lower trajectory limit based on the display pose; and selecting the subset of the set of Gaussians based on the determined upper trajectory limit and the determined lower trajectory limit.
Aspect 5 is the method of aspect 4, wherein determining the upper trajectory limit and the lower trajectory limit based on the display pose comprises: determining the upper trajectory limit and the lower trajectory limit based on a depth discontinuity threshold from the display pose.
Aspect 6 is the method of aspect 3, wherein selecting the subset of the set of Gaussians based on the display pose comprises: determining a region of interest (ROI) based on the display pose; and selecting the subset of the set of Gaussians based on the determined ROI.
Aspect 7 is the method of aspect 1, wherein the request comprises a request for the set of Gaussians, further comprising: selecting the set of Gaussians for the indication based on the request.
Aspect 8 is a method of graphics processing, comprising: transmitting a request for a set of Gaussians; receiving the set of Gaussians in response to a transmission of the request; performing depth-based reprojection based on a display pose; and performing alpha composition based on the received set of Gaussians and a performance of depth-based projection based on the display pose.
Aspect 9 is the method of aspect 8, further comprising: rasterizing the received set of Gaussians before a performance of alpha composition based on the depth-based projection and the received set of Gaussians.
Aspect 10 is the method of aspect 8, further comprising obtaining the display pose before performing the depth-based reprojection.
Aspect 11 is the method of aspect 8, wherein the request comprises an indication of the display pose, wherein the received set of Gaussians is based on the display pose.
Aspect 12 is the method of aspect 8, further comprising: selecting a subset of the set of Gaussians based on the display pose.
Aspect 13 is the method of aspect 12, wherein selecting the subset of the set of Gaussians based on the display pose comprises: determining an upper trajectory limit and a lower trajectory limit based on the display pose; and selecting the subset of the set of Gaussians based on the determined upper trajectory limit and the determined lower trajectory limit.
Aspect 14 is the method of aspect 13, wherein determining the upper trajectory limit and the lower trajectory limit based on the display pose comprises: determining the upper trajectory limit and the lower trajectory limit based on a depth discontinuity threshold from the display pose.
Aspect 15 is the method of aspect 12, wherein selecting the subset of the set of Gaussians based on the display pose comprises: determining a region of interest (ROI) based on the display pose; and selecting the subset of the set of Gaussians based on the determined ROI.
Aspect 16 is a method of graphics processing, comprising: obtaining an indication of a set of Gaussians; performing depth-based reprojection based on a display pose; and performing alpha composition based on the received set of Gaussians and a performance of depth-based projection based on the display pose.
Aspect 17 is the method of aspect 16, further comprising: rasterizing the received set of Gaussians before a performance of alpha composition based on the depth-based projection and the received set of Gaussians.
Aspect 18 is the method of aspect 16, further comprising obtaining the display pose before performing the depth-based reprojection.
Aspect 19 is the method of aspect 16, wherein the request comprises an indication of the display pose, wherein the received set of Gaussians is based on the display pose.
Aspect 20 is the method of aspect 16, further comprising: selecting a subset of the set of Gaussians based on the display pose.
Aspect 21 is the method of aspect 20, wherein selecting the subset of the set of Gaussians based on the display pose comprises: determining an upper trajectory limit and a lower trajectory limit based on the display pose; and selecting the subset of the set of Gaussians based on the determined upper trajectory limit and the determined lower trajectory limit.
Aspect 22 is the method of aspect 21, wherein determining the upper trajectory limit and the lower trajectory limit based on the display pose comprises: determining the upper trajectory limit and the lower trajectory limit based on a depth discontinuity threshold from the display pose.
Aspect 23 is the method of any of aspects 20 to 22, wherein selecting the subset of the set of Gaussians based on the display pose comprises: determining a region of interest (ROI) based on the display pose; and selecting the subset of the set of Gaussians based on the determined ROI.
Aspect 24 is the method of any of aspects 16 to 22, further comprising: transmitting a request for a set of Gaussians before obtaining the set of Gaussians.
Aspect 25 is an apparatus for graphics processing including at least one processor coupled to a memory and configured to implement a method as in any of aspects 1-24
Aspect 26 may be combined with aspect 25 and includes that the apparatus is a wireless communication device.
Aspect 27 is an apparatus for graphics processing including means for implementing a method as in any of aspects 1-24
Aspect 28 is a computer-readable medium (e.g., a non-transitory computer-readable medium) storing computer executable code, the code when executed by at least one processor causes the at least one processor to implement a method as in any of aspects 1-24

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
obtain a set of frames;
determine a set of Gaussians based on the set of frames;
receive a request for a subset of the set of Gaussians, wherein the request comprises an indication of a display pose;
select the subset of the set of Gaussians based on the indication of the display pose; and
transmit an indication of the subset of the set of Gaussians in response to the request.

2. The apparatus of claim 1, wherein, to obtain the set of frames, the processor is configured to:
receive the set of frames from a set of cameras or a client entity.

3. The apparatus of claim 1, wherein, to select the subset of the set of Gaussians based on the display pose, the processor is configured to:
determine an upper trajectory limit and a lower trajectory limit based on the display pose; and
select the subset of the set of Gaussians based on the determined upper trajectory limit and the determined lower trajectory limit.

4. The apparatus of claim 3, wherein, to determine the upper trajectory limit and the lower trajectory limit based on the display pose, the processor is configured to:
determine the upper trajectory limit and the lower trajectory limit based on a depth discontinuity threshold from the display pose.

5. The apparatus of claim 1, wherein, to select the subset of the set of Gaussians based on the display pose, the processor is configured to:
determine a region of interest (ROI) based on the display pose; and
select the subset of the set of Gaussians based on the determined ROI.

6. The apparatus of claim 1, wherein the apparatus comprises a wireless communication device.

7. An apparatus for graphics processing, comprising:
a memory; and
a processor coupled to the memory and, based on information stored in the memory, the processor is configured to:
determine a display pose of a user;
obtain a set of Gaussians corresponding to the display pose;
perform depth-based reprojection on a frame based on the display pose; and
perform alpha composition based on the obtained set of Gaussians and the performance of depth-based projection based on the display pose.

8. The apparatus of claim 7, wherein the processor is further configured to:
rasterize the obtained set of Gaussians before the performance of alpha composition based on the depth-based projection and the obtained set of Gaussians.

9. The apparatus of claim 7, wherein the processor is further configured to:
obtain the display pose before performing the depth-based reprojection.

10. The apparatus of claim 7, wherein the processor is further configured to:
transmit a request comprising an indication of the display pose, wherein the obtained set of Gaussians is based on the display pose.

11. The apparatus of claim 7, wherein the processor is further configured to:
select a subset of the set of Gaussians based on the display pose.

12. The apparatus of claim 11, wherein, to select the subset of the set of Gaussians based on the display pose, the processor is configured to:
determine an upper trajectory limit and a lower trajectory limit based on the display pose; and
select the subset of the set of Gaussians based on the determined upper trajectory limit and the determined lower trajectory limit.

13. The apparatus of claim 12, wherein, to determine the upper trajectory limit and the lower trajectory limit based on the display pose, the processor is configured to:
determine the upper trajectory limit and the lower trajectory limit based on a depth discontinuity threshold from the display pose.

14. The apparatus of claim 11, wherein, to select the subset of the set of Gaussians based on the display pose, the processor is configured to:
determine a region of interest (ROI) based on the display pose; and
select the subset of the set of Gaussians based on the determined ROI.

15. A method of graphics processing, comprising:
obtaining a set of frames;
determining a set of Gaussians based on the set of frames;
receiving a request for a subset of the set of Gaussians, wherein the request comprises an indication of a display pose;
selecting the subset of the set of Gaussians based on the indication of the display pose; and
transmitting an indication of the subset of the set of Gaussians in response to the request.

16. The method of claim 15, wherein obtaining the set of frames comprises:
receiving the set of frames from a set of cameras or a client entity.

17. The method of claim 15, wherein selecting the subset of the set of Gaussians based on the display pose comprises:
determining an upper trajectory limit and a lower trajectory limit based on the display pose; and
selecting the subset of the set of Gaussians based on the determined upper trajectory limit and the determined lower trajectory limit.

18. The method of claim 17, wherein determining the upper trajectory limit and the lower trajectory limit based on the display pose comprises:
determining the upper trajectory limit and the lower trajectory limit based on a depth discontinuity threshold from the display pose.

19. The method of claim 15, wherein selecting the subset of the set of Gaussians based on the display pose comprises:
determining a region of interest (ROI) based on the display pose; and
selecting the subset of the set of Gaussians based on the determined ROI.

20. The method of claim 15, wherein the request comprises a request for the set of Gaussians, wherein transmitting the indication of the subset of the set of Gaussians in response to the request comprises:
transmitting an indication of the set of Gaussians in response to the request.
